(19) United States
(12) Patent Application Publication
(10) Pub. No.: US 2005/0258576 A1
(43) Pub. Date: Nov. 24, 2005

(54) Patterned fibrous structures

(76) Inventors: Mark Edwin Forry, Hamilton, OH (US); Wayne Robert Fisher, Cincinnati, OH (US); Lamar Ahmed Elony, Cincinnati, OH (US); Michael Gomer Stelljes JR., Mason, OH (US); Kevin Benson McNeil, Loveland, OH (US); John Jianbin Zhang, Cincinnati, OH (US); Dean Phan, West Chester, OH (US); Timothy Jude Lorenz, Cincinnati, OH (US); Paul Dennis Trokhan, Hamilton, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/105,998

(22) Filed: Apr. 14, 2005

Related U.S. Application Data
(63) Continuation-in-part of application No. 10/840,042, filed on May 6, 2004.

(51) Int. Cl. B27N 1/00; B29C 43/22

(52) U.S. Cl. 264/517

(57) ABSTRACT

Patterned fibrous structures, especially patterned latex-containing fibrous structures, single- or multi-ply sanitary tissue products comprising same, and methods for making such fibrous structures and/or sanitary tissue products are provided.

### CROSS REFERENCE TO RELATED APPLICATION

This application is a continuation-in-part of prior copending U.S. application Ser. No. 10/840,042, filed on May 6, 2004.

### FIELD OF THE INVENTION

The present invention relates to patterned fibrous structures, more particularly patterned latex-containing fibrous structures, single- or multi-ply sanitary tissue products comprising same, and methods for making such fibrous structures and/or sanitary tissue products.

### BACKGROUND OF THE INVENTION

Patterned fibrous structures and patterned latex-containing fibrous structures are known in the art. However, patterned latex-containing fibrous structures wherein at least one surface of the patterned fibrous structure exhibits a deformation height of at least about 650 μm are not known in the art.

Accordingly, there exists a need for patterned fibrous structures, especially patterned latex-containing fibrous structures, that comprise at least one surface that exhibits a deformation height of at least about 650 μm, a sanitary tissue product comprising same, and methods for making such fibrous structures and/or sanitary tissue products.

### SUMMARY OF THE INVENTION

The present invention fulfills the need described above by providing a patterned fibrous structure, especially a patterned latex-containing fibrous structure.

In one aspect of the present invention, a patterned fibrous structure comprising latex, preferably wherein the fibrous structure comprises a first surface and a second surface, wherein at least one of the first and second surfaces exhibits a deformation height of at least about 650 μm, is provided.

In another aspect of the present invention, a single- or multi-ply sanitary tissue product comprising a patterned fibrous structure according to the present invention is provided.

In even another aspect of the present invention, a method for making a patterned fibrous structure comprising latex and/or a single-ply sanitary tissue product comprising such patterned fibrous structure, said method comprising the steps of:
a. providing a fibrous structure comprising latex; and
b. subjecting the fibrous structure to a deformation generating process such that a patterned fibrous structure and/or a single-ply sanitary tissue product comprising such patterned fibrous structure is formed, is provided.

In still another aspect of the present invention, a method for making a patterned fibrous structure comprising latex and/or a single-ply sanitary tissue product comprising such patterned fibrous structure, said method comprising the steps of:
a. providing a patterned fibrous structure and/or a single-ply sanitary tissue product comprising such patterned fibrous structure; and
b. applying latex to the patterned fibrous structure and/or the single-ply sanitary tissue comprising such patterned fibrous structure, is provided.

In even still another aspect of the present invention, a method for making a patterned fibrous structure comprising latex and/or a single-ply sanitary tissue product comprising such patterned fibrous structure, said method comprising the steps of:
a. providing a fibrous furnish;
b. depositing the fibrous furnish on a foraminous forming surface to form an embryonic fibrous web;
c. drying the embryonic fibrous web such that a fibrous structure is formed;
d. applying latex to the fibrous furnish and/or the embryonic fibrous web and/or the fibrous structure; and
e. subjecting the fibrous structure to a deformation generating process such that a patterned fibrous structure and/or a single-ply sanitary tissue product comprising such patterned fibrous structure is formed, is provided.

In yet another aspect of the present invention, a method for making a patterned fibrous structure comprising latex and/or a single-ply sanitary tissue product comprising such patterned fibrous structure, said method comprising the steps of:
a. providing an airborne fiber stream;
b. depositing the airborne fiber stream onto a forming surface to form an air laid fibrous structure;
c. applying latex to the air laid fibrous structure; and
d. subjecting the air laid fibrous structure to a deformation generating process such that a patterned air laid fibrous structure is formed, is provided.

In even yet another aspect of the present invention, a method for making a patterned multi-ply sanitary tissue product, said method comprising the steps of:
a. providing a first fibrous structure;
b. providing a second fibrous structure;
c. attaching the second fibrous structure to the first fibrous structure to form a multi-ply sanitary tissue product;
d. subjecting at least one surface of the first fibrous structure, second fibrous structure and/or the multi-ply sanitary tissue product to a deformation generating process such that a patterned sanitary tissue product is formed; and
e. applying latex to at least one of the first fibrous structure, the second fibrous structure and/or the multi-ply sanitary tissue product, is provided.

The latex can be applied prior to, during, or after the step of deforming the fibrous structures and/or sanitary tissue products.

The methods of the present invention may further comprise a step of drying the fibrous structure, especially if it is a wet laid fibrous structure and/or curing the latex.

Accordingly, the present invention provides a patterned latex-containing fibrous structure, a single- or multi-ply sanitary tissue product comprising a patterned latex-containing fibrous structure, and methods for making such patterned fibrous structures and/or sanitary tissue products.

### BRIEF DESCRIPTION OF THE DRAWINGS

FIG. 1 is a schematic illustration of various forms of deformation generating processes and patterned fibrous structures produced therefrom.

FIG. 2 is a side view of the gap between two engaged emboss rolls of one embodiment of an embossing process suitable for use in the present invention.

FIG. 3 is a side view of an embodiment of a patterned latex-containing fibrous structure according to the present invention.

FIG. 4 is a schematic representation of one embodiment of an air laid process for making a fibrous structure in accordance with the present invention.

### DETAILED DESCRIPTION OF THE INVENTION

Definitions

“Fiber” as used herein means an elongate particulate having an apparent length greatly exceeding its apparent width, i.e. a length to diameter ratio of at least about 10. More specifically, as used herein, “fiber” refers to papermaking fibers. The present invention contemplates the use of a variety of papermaking fibers, such as, for example, natural fibers or synthetic fibers, or any other suitable fibers, and any combination thereof. Papermaking fibers useful in the present invention include cellulosic fibers commonly known as wood pulp fibers. Other cellulosic fibrous pulp fibers, such as cotton linters, bagasse, etc., can be utilized and are intended to be within the scope of this invention. Synthetic fibers, such as rayon, polyethylene, polypropylene, polyethylene terephthalate, co-polyethylene terephthalate fibers, may also be utilized alone or in combination with other fibers, such as natural cellulosic fibers. The synthetic fibers may comprise thermal bonded synthetic fibers.

Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking. In addition to the above, fibers and/or filaments made from polymers, specifically hydroxyl polymers may be used in the present invention. Nonlimiting examples of suitable hydroxyl polymers include polyvinyl alcohol, starch, starch derivatives, chitosan, chitosan derivatives, cellulose derivatives, gums, arabinans, galactans and mixtures thereof. In addition, protein fibers may also be used in the fibrous structures of the present invention.

The fibers may be of any suitable size, short, long or continuous.

“Wet Burst Strength” as used herein is a measure of the ability of a fibrous structure and/or a sanitary tissue product incorporating a fibrous structure to absorb energy, when wet and subjected to deformation normal to the plane of the fibrous structure and/or sanitary tissue product. In one embodiment, the fibrous structures and/or sanitary tissue products according to the present invention exhibit a wet burst strength of at least about 100 g and/or at least about 150 g and/or at least about 200 g and/or at least about 300 g and/or at least about 305 g.

“Basis Weight” as used herein is the weight per unit area of a sample reported in lbs/3000 ft² or g/m². Basis weight is measured by preparing one or more samples of a certain area (m²) and weighing the sample(s) of a fibrous structure according to the present invention and/or a sanitary tissue product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²). The basis weight (g/m²) is calculated by dividing the average weight (g) by the average area of the samples (m²). In one embodiment, the fibrous structures and/or sanitary tissue products according to the present invention exhibit a basis weight of from about 10 g/m² to about 120 g/m² and/or from about 20 g/m² to about 60 g/m².

“Machine Direction” or “MD” as used herein means the direction parallel to the flow of the fibrous structure through the papermaking machine and/or product manufacturing equipment.

“Cross Machine Direction” or “CD” as used herein means the direction perpendicular to the machine direction in the same plane of the fibrous structure.

“Stretch” as used herein is determined by measuring a fibrous structure's Dry Tensile Strength in MD and/or CD. The fibrous structures and/or sanitary tissue products comprising such fibrous structures of the present invention may have a CD Stretch at Peak Load of greater than about 10% and/or greater than about 14% and/or greater than about 18% and/or from about 10% to about 30% and/or from about 14% to about 28% and/or from about 18% to about 25%. In addition, the fibrous structures and/or sanitary tissue products comprising such fibrous structures of the present invention may have a MD Stretch at Peak Load of greater than about 10% and/or greater than about 14% and/or greater than about 18% and/or from about 10% to about 30% and/or from about 14% to about 28% and/or from about 18% to about 25%. In one embodiment, the fibrous structure exhibits a CD and MD Stretch at Peak Load that are identical or substantially identical. For example, a CD Stretch at Peak Load of about 16% and a MD Stretch at Peak Load of about 16%. In another embodiment, the fibrous structure and/or sanitary tissue product comprising such fibrous structure of the present invention exhibits a Stretch at Peak Load, in any direction, of at least about 10%.

“Sheet Caliper” or “Caliper” as used herein means the macroscopic thickness of a sample. In one embodiment, the patterned fibrous structure and/or sanitary tissue product according to the present invention exhibits a sheet caliper of at least about 20 mils and/or at least about 30 mils and/or at least about 40 mils as measured by the Sheet Caliper Test Method.

“Effective Caliper” as used herein means the radial thickness a layer of fibrous structure and/or sanitary tissue product occupies within a convolutely wound roll of such fibrous structure and/or sanitary tissue product. In order to facilitate the determination of effective caliper, an Effective Caliper Test Method is described herein. The effective caliper of a fibrous structure and/or sanitary tissue product can differ from the sheet caliper of the fibrous structure and/or sanitary tissue product due to winding tension, nesting of deformations, etc.

“Absorbent” and “absorbency” as used herein means the characteristic of the fibrous structure which allows it to take up and retain fluids, particularly water and aqueous solutions and suspensions. In evaluating the absorbency of paper, not only is the absolute quantity of fluid a given amount of paper will hold significant, but the rate at which the paper will absorb the fluid is also. Absorbency is measured here in by the Horizontal Full Sheet (HFS) test method described in the Test Methods section herein. In one embodiment, the fibrous structures and/or sanitary tissue products according to the present invention exhibit an HFS absorbency of greater than about 5 g/g and/or greater than about 8 g/g and/or greater than about 10 g/g up to about 100 g/g. In another nonlimiting embodiment, the fibrous structures and/or sanitary tissue products according to the present invention exhibit an HFS absorbency of from about 12 g/g to about 20 g/g.

“Apparent Density” or “Density” as used herein means the basis weight of a sample divided by the caliper with appropriate conversions incorporated therein. Apparent density used herein has the units g/cm³ (alternatively g/cc). In one embodiment, the fibrous structures and/or sanitary tissue products according to the present invention exhibit a density of about 0.10 g/cc or less and/or a density of about 0.07 g/cc or less.

“Ply” or “Plies” as used herein means an individual fibrous structure optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself.

“Sanitary tissue product” as used herein means a wiping implement for post-urinary and post-bowel movement cleaning (toilet tissue), for otorhinolaryngolical discharges (facial tissue), and multi-functional absorbent and/or cleaning uses (absorbent towels and/or napkins).

“Patterned fibrous structure” and/or “patterned sanitary tissue product” as used herein means a fibrous structure and/or sanitary tissue product, made from any process known in the art that has at least one surface that exhibits a deformation height of at least about 650 μm. In other words, the fibrous structure and/or sanitary tissue product comprises at least one surface that comprises at least one deformation that exhibits a deformation height of at least about 650 μm. In one embodiment, both surfaces of the fibrous structure and/or sanitary tissue product comprise at least one deformation that exhibits a deformation height of at least about 650 μm.

“Deformation height” is measured according to the Deformation Height Test Method described herein. The patterned fibrous structure according to the present invention comprises a first surface and a second surface, wherein at least one of the first and second surfaces may exhibit a deformation height of at least about 650 μm and/or at least about 1000 μm and/or at least about 1250 μm and/or at least about 1500 μm. In other embodiments, the patterned fibrous structure comprises a first surface and a second surface, wherein at least one of the first and second surfaces may exhibit a deformation height of from about 650 μm to about 3000 μm and/or from about 1000 μm to about 2000 μm and/or from about 1000 μm to about 1500 μm as measured by the Deformation Height Test Method described herein. Generally, the upper limit of the deformation height is restricted by the ability of the fibrous structure to resist pin holes or tearing during a deformation generating process.

“Deformation” as used herein means a recess or a protrusion present on a fibrous structure's surface and/or sanitary tissue product's surface. A deformation may be produced on the surface of a fibrous structure and/or sanitary tissue product by any suitable means known in the art.

Patterned Fibrous Structure

The patterned fibrous structure according to the present invention may comprise any fibrous structure type known in the industry, such as air laid fibrous structures and/or wet laid fibrous structures. Nonlimiting examples of suitable fibrous structure types and methods for making same are described in U.S. Pat. No. 4,191,609 issued Mar. 4, 1980 to Trokhan; U.S. Pat. No. 4,300,981 issued to Carstens on Nov. 17, 1981; U.S. Pat. No. 4,191,609 issued to Trokhan on Mar. 4, 1980; 4,514,345 issued to Johnson et al. on Apr. 30, 1985; U.S. Pat. No. 4,528,239 issued to Trokhan on Jul. 9, 1985; U.S. Pat. No. 4,529,480 issued to Trokhan on Jul. 16, 1985; U.S. Pat. No. 4,637,859 issued to Trokhan on Jan. 20, 1987; U.S. Pat. No. 5,245,025 issued to Trokhan et al. on Sep. 14, 1993; U.S. Pat. No. 5,275,700 issued to Trokhan on Jan. 4, 1994; U.S. Pat. No. 5,328,565 issued to Rasch et al. on Jul. 12, 1994; U.S. Pat. No. 5,334,289 issued to Trokhan et al. on Aug. 2, 1994; U.S. Pat. No. 5,364,504 issued to Smurkowski et al. on Nov. 15, 1995; U.S. Pat. No. 5,527,428 issued to Trokhan et al. on Jun. 18, 1996; U.S. Pat. No. 5,556,509 issued to Trokhan et al. on Sep. 17, 1996; U.S. Pat. No. 5,628,876 issued to Ayers et al. on May 13, 1997; U.S. Pat. No. 5,629,052 issued to Trokhan et al. on May 13, 1997; U.S. Pat. No. 5,637,194 issued to Ampulski et al. on Jun. 10, 1997; U.S. Pat. No. 5,411,636 issued to Hermans et al. on May 2, 1995; EP 677612 published in the name of Wendt et al. on Oct. 18, 1995.

The patterned fibrous structure in accordance with the present invention may comprise a fibrous structure, known in the art, selected from the group consisting of: through-air-dried fibrous structures, differential density fibrous structures, wet laid fibrous structures, air laid fibrous structures (examples of which are described in U.S. Pat. Nos. 3,949,035 and 3,825,381), conventional dried fibrous structures, creped or uncreped fibrous structures, patterned-densified or non-patterned-densified fibrous structures, compacted or uncompacted fibrous structures, nonwoven fibrous structures comprising synthetic or multicomponent fibers, homogeneous or multilayered fibrous structures and mixtures thereof.

In one embodiment, the air laid fibrous structure is selected from the group consisting of thermal bonded air laid (TBAL) fibrous structures, latex bonded air laid (LBAL) fibrous structures and mixed bonded air laid (MBAL) fibrous structures.

The patterned fibrous structure may exhibit a substantially uniform density or may exhibit differential density regions, in other words regions of high density compared to other regions within the patterned fibrous structure. Typically, when a fibrous structure is not pressed against a cylindrical dryer, such as a Yankee dryer, while the fibrous structure is still wet and supported by a through-air-drying fabric or by another fabric or when an air laid fibrous structure is not spot bonded, the fibrous structure typically exhibits a substantially uniform density.

In one embodiment, the fibrous structure of the present invention comprises about 100% wood pulp fibers.

Latex

The patterned fibrous structure of the present invention may comprise latex.

The latex may be a natural latex or a synthetic latex. The latex may exhibit a Tg of from about −65° C. to about 100° C. and/or from about −45° C. to about 100° C. The latex may be crosslinkable. The latex may be charged (anionic or cationic) or uncharged (nonionic). Nonlimiting examples of suitable latexes include vinyl acetates, ethylene-vinyl acetate copolymers, acrylate copolymers, styrene butadiene copolymers and mixtures thereof.

Suitable latexes for use in the present invention are commercially available from Dow Chemical Company under the trade-name UCAR, from National Starch and Chemical Company under the trade-names DUR-O-SET, NACRYLIC and ELITE, from BASF under the trade-name ACRONAL and STYROFAN, and from Air Products and Chemicals, Inc. under the trade-name AIRFLEX.

The latex may be applied to the patterned fibrous structure prior to, during or after being subjected to a deformation generating process. Application of latex to the patterned fibrous structure may occur by any suitable means known in the art. Preferably, the latex is applied to the patterned fibrous structure prior to being subjected to a deformation generating process. Nonlimiting examples of suitable application methods include spraying, dipping, brushing, slot extruding, gravure printing, flexo printing, coating, ink jet, hot melt, impregnating and mixtures thereof. The latex may be applied to the patterned fibrous structure at any level based on the total weight of the patterned fibrous structure. In one embodiment, the latex is applied to the patterned fibrous structure at a level of from about 0.1% to about 50% and/or from about 3% to about 40% and/or from about 4% to about 20% by total weight of the patterned fibrous structure.

The latex may be present on the surface of the patterned fibrous structure at a level of from about 1% to about 100% and/or from about 3% to about 85% and/or from about 3% to about 15% of the surface area of at least one surface of the patterned fibrous structure. The latex may be present on at least one surface of the patterned fibrous structure of the present invention in a random or non-random pattern.

In one embodiment, the latex is predominantly present on high density regions of a differential density patterned fibrous structure. In other words, more than 50% and/or more than 60% and/or more than 70% of the total latex present on the surface of the patterned fibrous structure is present on high density regions of the differential density patterned fibrous structure.

Other Ingredients

In addition to latex, the embossed latex-containing fibrous structures and/or single- or multi-ply sanitary tissue product made therefrom may comprise one or more additional ingredients, such as softening agents, absorbency agents such as surfactants, wet strength agents (i.e., temporary wet strength agents and/or permanent wet strength agents), lotions, antibacterial agents, coloring agents such as print elements, perfumes and mixtures thereof.

Deformation Generating Processes

The patterned fibrous structures of the present invention may be made by subjecting a fibrous structure to a deformation generating process. Any suitable deformation generating process known in the art can be used so long as the deformation generating process produces a patterned fibrous structure having at least one surface that exhibits a deformation height of at least about 650 μm. Nonlimiting examples of deformation generating processes include embossing processes, differential densifying processes and/or forming a fibrous structure using a patterned forming and/or drying belt. Nonlimiting examples of patterned forming and/or drying belts are described in U.S. Pat. Nos. 4,637,859, 5,496,624 and 5,500,277.

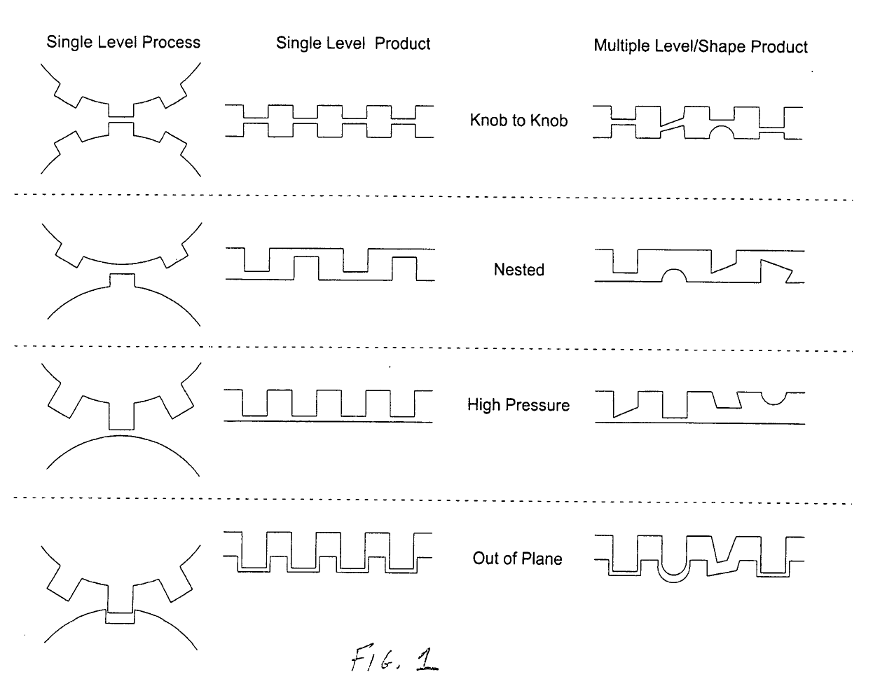

Nonlimiting examples of embossing processes, as generally shown in FIG. 1 include knob-to-knob embossing as described in U.S. Pat. No. 3,414,459, nested embossing as described in U.S. Pat. No. 3,867,225, especially deep nested embossing, high pressure embossing as described in U.S. Pat. No. 6,030,690, out of plane embossing and mixtures thereof. The embossing may be single level embossing or multiple level embossing as shown in FIG. 1. In addition to the above, dual-ply laminate embossing as described in U.S. Pat. Nos. 5,294,475 and 5,468,323 may be utilized also when a multi-ply sanitary tissue product is being formed.

A fibrous structure and/or sanitary tissue product in accordance with the present invention may be subjected to a deformation generating process prior to, during and/or after latex application.

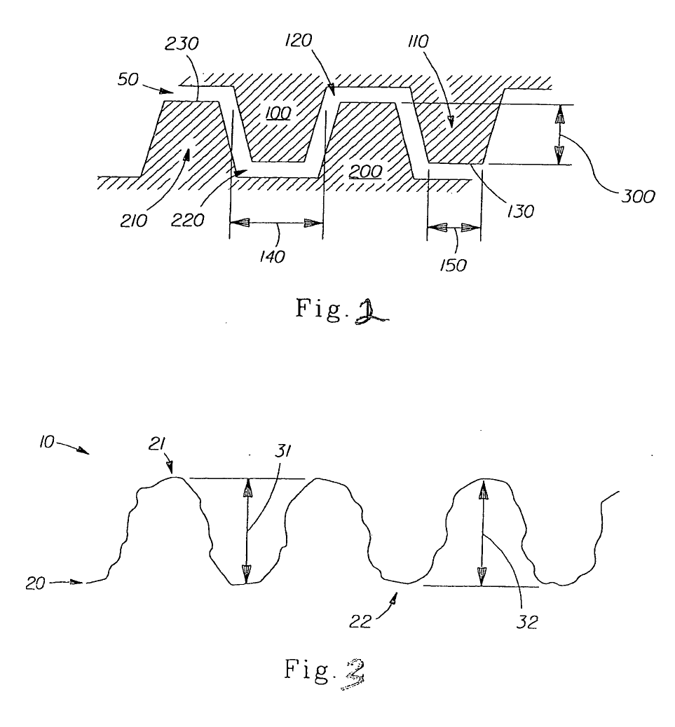

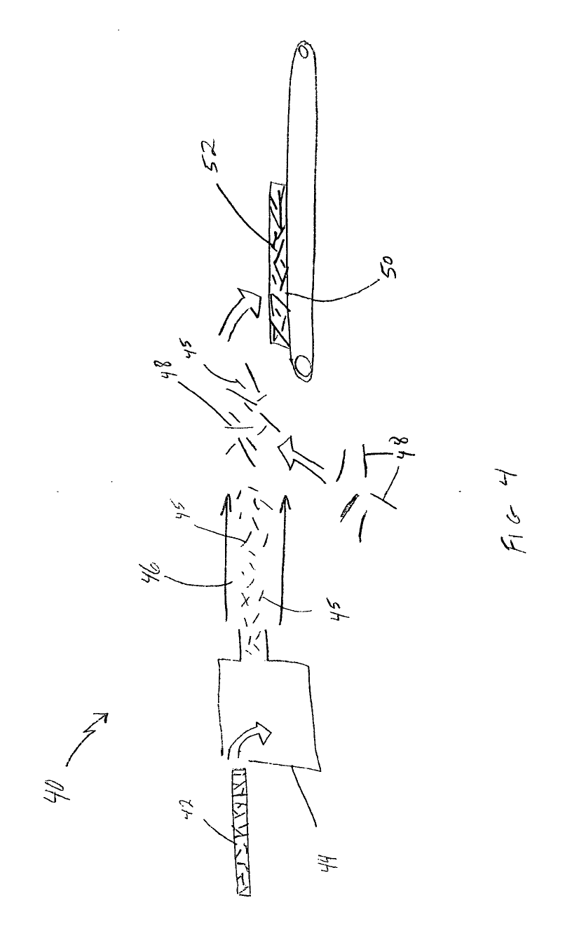

A nonlimiting example of a suitable deformation generating process is deep nested embossing, as shown in FIGS. 2 and 3. A latex-containing fibrous structure 20 is embossed in the gap 50 between two embossing rolls, 100 and 200. The embossing rolls 100 and 200 may be made from any material known for making such rolls, including without limitation steel, rubber, elastomeric materials, and combinations thereof. Each embossing roll 100 and 200 has a combination of emboss knobs 110 and 210 and gaps 120 and 220. Each emboss knob 110 for example has a knob base 140 and a knob face 150. The surface pattern of the rolls, that is the design of the various knobs and gaps, may be any design desired for the product, however for the deep nested embossing process the roll designs must be matched such that the knob face surface 130 of knob face 150 of one roll 100 extends into the gap 220 of the other roll 200 beyond the knob face surface 230 of the other roll 200 creating a depth of engagement 300. The depth of engagement 300 is the distance between the nested knob face surfaces 130 and 230. The depth of the engagement 300 used in producing the embossed latex-containing fibrous structures of the present invention can range from about 0.04 inch (0.1016 cm) to about 0.15 inch (0.381 cm) and/or from about 0.04 inch (0.1016 cm) to about 0.13 inch (0.332 cm) and/or from about 0.04 inch (0.1016 cm) to about 0.10 inch (0.254 cm) and/or from about 0.04 inch (0.1016 cm) to about 0.08 inch (0.2032 cm) and/or from about 0.05 inch (0.127 cm) to about 0.07 inch (0.1778 cm) such that a deformation height of at least about 650 μm and/or at least about 1000 μm and/or at least about 1250 μm and/or at least about 1500 μm is formed in one or both surfaces of the fibrous structure.

Referring to FIG. 3 the patterned latex-containing fibrous structure 20 exhibits deformations from a deep nested embossing process such that the first surface 21 exhibits a deformation height 31 of at least about 650 μm. Additionally, as shown in FIG. 3, the second surface 22 exhibits a deformation height 32 of at least about 650 μam. The deformation height, 31 and 32, of the respective surfaces, 21 and 22, of the patterned latex-containing fibrous structure is measured by the Deformation Height Test using a GFM Primos Optical Profiler as described in the Test Methods herein.

In one embodiment, the deformation generating process utilizes a patterned embossing roll and a non-patterned steel roll to create a patterned fibrous structure and/or sanitary tissue product in accordance with the present invention that comprises only one surface that exhibits a deformation height of at least 650 μm. The other surface exhibits a deformation height of less than 650 μm, preferably less than 300 μm and more preferably exhibits substantially no or completely no deformations. Such a deformation generating process may produce high density regions at the locations of the deformations that exhibit a deformation height of at least about 650 μm as compared to other regions of the patterned fibrous structure.

In other embodiments, the deformation generating process may produce in-plane high density regions as compared to other regions within the patterned fibrous structure. Alternatively, the deformation generating process may not produce in-plane high density regions as compared to other regions within the patterned fibrous structure.

The deformation generating process may produce deformations within at least one surface of the patterned fibrous structure, wherein the deformations comprise densified regions that exhibit a density of at least 2 times the density of the other non-deformation-containing regions of the patterned fibrous structure.

The deformation generating process may produce deformations within at least one surface of the patterned fibrous structure, wherein the deformations are phased relative to perforations and/or printed elements present in or on the patterned fibrous structure.

Further, the deformation generating process may produce deformations within at least one surface of the patterned fibrous structure, wherein the deformations individually or combined represent a discrete image that is separated from other discrete images present on the patterned fibrous structure by regions of the fibrous structure that do not contain deformations.

By subjecting the fibrous structure and/or sanitary tissue product of the present invention to a deformation generating process to form a patterned fibrous structure and/or patterned sanitary tissue product, the caliper of such patterned fibrous structure and/or patterned sanitary tissue product is increased relative to the identical non-patterned fibrous structure and/or non-patterned sanitary tissue product by at least 10% and/or at least 15%.

Sanitary Tissue Products

Sanitary tissue products of the present invention may comprise a patterned fibrous structure as described herein. Alternatively, the sanitary tissue products of the present invention may comprises a non-patterned fibrous structure wherein the sanitary tissue products are subjected to a deformation generating process according to the present invention, thus resulting in patterned sanitary tissue products.

The sanitary tissue product of the present invention may comprise one or more fibrous structures, especially patterned fibrous structures. Therefore, the sanitary tissue products may be single-ply or multi-ply products. If multi-ply, at least one of the fibrous structures of the sanitary tissue product is a fibrous structure, preferably a patterned fibrous structure, in accordance with the present invention.

The sanitary tissue product according to the present invention may be in roll form. When in roll form, the sanitary tissue product according to the present invention may be convolutely wound about a core or may be convolutely wound without a core.

In one embodiment, the patterned fibrous structure and/or sanitary tissue product, when in roll form, exhibits an average effective caliper that is greater than the average sheet caliper of the identical fibrous structure and/or sanitary tissue product, respectively, in its non-patterned form.

Methods for Making Fibrous Structures and/or Sanitary Tissue Products

The patterned fibrous structures, especially patterned latex-containing fibrous structures and/or sanitary tissue products comprising same, can be made by any suitable method known in the art. Nonlimiting examples of such methods are described hereinabove.

As shown in FIG. 4, a nonlimiting example of an air laid fibrous structure producing method 40 suitable for the present invention comprises the steps of opening of fibers from a compressed state 42, a hammer mill 44 is one device that can be used to individualize fibers 45 from a compressed state 42, dispersing the fibers 45 in a high velocity air stream 46, blending the fibers 45 with other fibers 48, if desired, depositing the fibers 45 or mixture of fibers 45 and 48 onto a forming surface or belt 50 such that an air laid fibrous structure 52 is formed. Once the air laid fibrous structure is formed additional treatments actions may be performed on it. Nonlimiting examples of such additional treatment actions include embossing, applying latex, drying, curing, printing, applying softening and/or strength agents, and winding into a roll. In addition to the blending step or in place of the blending step, different layers of fibers may be deposited onto the forming surface or belt. Also, steps of compacting the fibers into the fibrous structure and/or calendering the fibrous structure and/or using a heated emboss roll or rolls are also options within the method.

The methods of the present invention may further comprise a step of drying and/or curing the latex.

In the multi-ply sanitary tissue product methods, the second fibrous structure may be a non-latex-containing fibrous structure or a latex-containing fibrous structure. Further, the second fibrous structure may comprise a surface that exhibits an embossment height of at least about 650 μm or it may comprise a surface that does not exhibit an embossment height of at least about 650 μm.

Further, in the multi-ply sanitary tissue product methods, the first fibrous structure and second fibrous structure may be attached by any suitable method including non-adhesively attached and/or adhesively attached with plybond glue (cold glue and/or hot melt and/or hot glue). A nonlimiting example of a non-adhesive attaching method includes embossing the multi-ply sanitary tissue product after the fibrous structures have been combined (i.e., are in contact with one another).

Test Methods:

Deformation Height Test

Deformation height is measured using a GFM Primos Optical Profiler instrument commercially available from GFMesstechnik GmbH, Warthestraβe 21, D14513 Teltow/Berlin, Germany. The GFM Primos Optical Profiler instrument includes a compact optical measuring sensor based on the digital micro mirror projection, consisting of the following main components: a) DMD projector with 1024×768 direct digital controlled micro mirrors, b) CCD camera with high resolution (1300×1000 pixels), c) projection optics adapted to a measuring area of at least 27×22 mm, and d) recording optics adapted to a measuring area of at least 27×22 mm; a table tripod based on a small hard stone plate; a cold light source; a measuring, control, and evaluation computer; measuring, control, and evaluation software ODSCAD 4.0, English version; and adjusting probes for lateral (x-y) and vertical (z) calibration.

The GFM Primos Optical Profiler system measures the surface height of a sample using the digital micro-mirror pattern projection technique. The result of the analysis is a map of surface height (z) vs. xy displacement. The system has a field of view of 27×22 mm with a resolution of 21 microns. The height resolution should be set to between 0.10 and 1.00 micron. The height range is 64,000 times the resolution.

To measure a patterned fibrous structure and/or patterned sanitary tissue product sample do the following:
1. Turn on the cold light source. The settings on the cold light source should be 4 and C, which should give a reading of 3000K on the display;
2. Turn on the computer, monitor and printer and open the ODSCAD 4.0 Primos Software.
3. Select “Start Measurement” icon from the Primos taskbar and then click the “Live Pic” button.
4. Place a 30 mm by 30 mm sample of patterned fibrous structure or patterned sanitary tissue product conditioned at a temperature of 73° F.±2° F. (about 23° C.±1° C.) and a relative humidity of 50%±2% under the projection head and adjust the distance for best focus.
5. Click the “Pattern” button repeatedly to project one of several focusing patterns to aid in achieving the best focus (the software cross hair should align with the projected cross hair when optimal focus is achieved). Position the projection head to be normal to the sample surface.
6. Adjust image brightness by changing the aperture on the lens through the hole in the side of the projector head and/or altering the camera “gain” setting on the screen. Do not set the gain higher than 7 to control the amount of electronic noise. When the illumination is optimum, the red circle at bottom of the screen labeled “I.O.” will turn green.
7. Select Technical Surface/Rough measurement type.
8. Click on the “Measure” button. This will freeze on the live image on the screen and, simultaneously, the image will be captured and digitized. It is important to keep the sample still during this time to avoid blurring of the captured image. The image will be captured in approximately 20 seconds.

9. If the image is satisfactory, save the image to a computer file with “.omc” extension. This will also save the camera image file “.kam”.
10. To move the date into the analysis portion of the software, click on the clipboard/man icon.
11. Now, click on the icon “Draw Cutting Lines”. Make sure active line is set to line 1. Move the cross hairs to the lowest point on the left side of the computer screen image and click the mouse. Then move the cross hairs to the lowest point on the right side of the computer screen image on the current line and click the mouse. Now click on “Align” by marked points icon. Now click the mouse on the lowest point on this line, and then click the mouse on the highest point on this line. Click the “Vertical” distance icon. Record the distance measurement. Now increase the active line to the next line, and repeat the previous steps, do this until all lines have been measured (six (6) lines in total. Take the average of all recorded numbers, and if the units is not micrometers, convert it to micrometers (μm). This number is the deformation height. Repeat this procedure for another image in the patterned fibrous structure and/or patterned sanitary tissue product sample and take the average of the deformation heights.
   Wet Burst Strength Test

Wet burst strength may be measured using a Thwing-Albert Burst Tester Cat. No. 177 equipped with a 2000 g load cell commercially available from Thwing-Albert Instrument Company, Philadelphia, Pa.

Wet burst strength is measured by taking two (2) multi-ply sanitary tissue product samples. Using scissors, cut the samples in half in the MD so that they are approximately 228 mm in the machine direction and approximately 114 mm in the cross machine direction, each two (2) plies thick (you now have 4 samples). First, condition the samples for two (2) hours at a temperature of 73° F.±2° F. (about 23° C.±1° C.) and a relative humidity of 50%±2%. Next age the samples by stacking the samples together with a small paper clip and “fan” the other end of the stack of samples by a clamp in a 105° C. (±1° C.) forced draft oven for 5 minutes (±10 seconds). After the heating period, remove the sample stack from the oven and cool for a minimum of three (3) minutes before testing. Take one sample strip, holding the sample by the narrow cross machine direction edges, dipping the center of the sample into a pan filled with about 25 mm of distilled water. Leave the sample in the water four (4) (±0.5) seconds. Remove and drain for three (3) (±0.5) seconds holding the sample so the water runs off in the cross machine direction. Proceed with the test immediately after the drain step. Place the wet sample on the lower ring of a sample holding device of the Burst Tester with the outer surface of the sample facing up so that the wet part of the sample completely covers the open surface of the sample holding ring. If wrinkles are present, discard the samples and repeat with a new sample. After the sample is properly in place on the lower sample holding ring, turn the switch that lowers the upper ring on the Burst Tester. The sample to be tested is now securely gripped in the sample holding unit. Start the burst test immediately at this point by pressing the start button on the Burst Tester. A plunger will begin to rise toward the wet surface of the sample. At the point when the sample tears or ruptures, report the maximum reading. The plunger will automatically reverse and return to its original starting position. Repeat this procedure on three (3) more samples for a total of four (4) tests, i.e., four (4) replicates. Report the results as an average of the four (4) replicates, to the nearest g.

Sheet Caliper Test

Sheet Caliper or Caliper of a sample of sanitary tissue product is determined by cutting a sample of the sanitary tissue product such that it is larger in size than a load foot loading surface where the load foot loading surface has a circular surface area of about 3.14 in². The sample is confined between a horizontal flat surface and the load foot loading surface. The load foot loading surface applies a confining pressure to the sample of 14.7 g/cm² (about 0.21 psi). The caliper is the resulting gap between the flat surface and the load foot loading surface. Such measurements can be obtained on a VIR Electronic Thickness Tester Model II available from Thwing-Albert Instrument Company, Philadelphia, Pa. The caliper measurement is repeated and recorded at least five (5) times so that an average caliper can be calculated. The result is reported in mils.

Effective Caliper Test

Effective caliper of a fibrous structure and/or sanitary tissue product in roll form is determined by the following equation:
EC=(RD²−CD²)/(0.00127×SC×SL)
wherein EC is effective caliper in mils of a single sheet in a wound roll of fibrous structure and/or sanitary tissue product; RD is roll diameter in inches; CD is core diameter in inches; SC is sheet count; and SL is sheet length in inches.
Total Dry Tensile Strength Test

“Total Dry Tensile Strength” or “TDT” of a fibrous structure of the present invention and/or a paper product comprising such fibrous structure is measured as follows. One (1) inch by five (5) inch (2.5 cm×12.7 cm) strips of fibrous structure and/or paper product comprising such fibrous structure are provided. The strip is placed on an electronic tensile tester Model 1122 commercially available from Instron Corp., Canton, Mass. in a conditioned room at a temperature of 73° F.±4° F. (about 28° C.±2.2° C.) and a relative humidity of 50%±10%. The crosshead speed of the tensile tester is 2.0 inches per minute (about 5.1 cm/minute) and the gauge length is 4.0 inches (about 10.2 cm). The TDT is the arithmetic total of MD and CD tensile strengths of the strips.

Prior to tensile testing, the paper samples to be tested should be conditioned according to TAPPI Method #T402OM-88. All plastic and paper board packaging materials must be carefully removed from the paper samples prior to testing. The paper samples should be conditioned for at least 2 hours at a relative humidity of 48 to 52% and within a temperature range of 22 to 24° C. Sample preparation and all aspects of the tensile testing should also take place within the confines of the constant temperature and humidity room.

Discard any damaged product. Next, remove 5 strips of four usable units (also termed sheets) and stack one on top to the other to form a long stack with the perforations between the sheets coincident. Identify sheets 1 and 3 for machine direction tensile measurements and sheets 2 and 4 for cross direction tensile measurements. Next, cut through the perforation line using a paper cutter (JDC-1-10 or JDC-1-12 with safety shield from Thwing-Albert Instrument Co. of Philadelphia, Pa.) to make 4 separate stocks. Make sure stacks 1 and 3 are still identified for machine direction testing and stacks 2 and 4 are identified for cross direction testing.

Cut two 1 inch (2.54 cm) wide strips in the machine direction from stacks 1 and 3. Cut two 1 inch (2.54 cm) wide strips in the cross direction from stacks 2 and 4. There are now four 1 inch (2.54 cm) wide strips for machine direction tensile testing and four 1 inch (2.54 cm) wide strips for cross direction tensile testing. For these finished product samples, all eight 1 inch (2.54 cm) wide strips are five usable units (also termed sheets) thick.

For unconverted stock and/or reel samples, cut a 15 inch (38.1 cm) by 15 inch (38.1 cm) sample which is 8 plies thick from a region of interest of the sample using a paper cutter (JDC-1-10 or JDC-1-12 with safety shield from Thwing-Albert Instrument Co of Philadelphia, Pa.). Ensure one 15 inch (38.1 cm) cut runs parallel to the machine direction while the other runs parallel to the cross direction. Make sure the sample is conditioned for at least 2 hours at a relative humidity of 48 to 52% and within a temperature range of 22 to 24° C. Sample preparation and all aspects of the tensile testing should also take place within the confines of the constant temperature and humidity room.

From this preconditioned 15 inch (38.1 cm) by 15 inch (38.1 cm) sample which is 8 plies thick, cut four strips 1 inch (2.54 cm) by 7 inch (17.78 cm) with the long 7 (17.78 cm) dimension running parallel to the machine direction. Note these samples as machine direction reel or unconverted stock samples. Cut an additional four strips 1 inch (2.54 cm) by 7 inch (17.78 cm) with the long 7 (17.78 cm) dimension running parallel to the cross direction. Note these samples as cross direction reel or unconverted stock samples. Ensure all previous cuts are made using a paper cutter (JDC-1-10 or JDC-1-12 with safety shield from Thwing-Albert Instrument Co. of Philadelphia, Pa.). There are now a total of eight samples: four 1 inch (2.54 cm) by 7 inch (17.78 cm) strips which are 8 plies thick with the 7 inch (17.78 cm) dimension running parallel to the machine direction and four 1 inch (2.54 cm) by 7 inch (17.78 cm) strips which are 8 plies thick with the 7 inch (17.78 cm) dimension running parallel to the cross direction.

For the actual measurement of the tensile strength, use a Thwing-Albert Intelect II Standard Tensile Tester (Thwing-Albert Instrument Co. of Philadelphia, Pa.). Insert the flat face clamps into the unit and calibrate the tester according to the instructions given in the operation manual of the Thwing-Albert Intelect II. Set the instrument crosshead speed to 4.00 in/min (10.16 cm/min) and the 1st and 2nd gauge lengths to 2.00 inches (5.08 cm). The break sensitivity should be set to 20.0 grams and the sample width should be set to 1.00 inch (2.54 cm) and the sample thickness at 0.025 inch (0.0635 cm).

A load cell is selected such that the predicted tensile result for the sample to be tested lies between 25% and 75% of the range in use. For example, a 5000 gram load cell may be used for samples with a predicted tensile range of 1250 grams (25% of 5000 grams) and 3750 grams (75% of 5000 grams). The tensile tester can also be set up in the 10% range with the 5000 gram load cell such that samples with predicted tensiles of 125 grams to 375 grams could be tested.

Take one of the tensile strips and place one end of it in one clamp of the tensile tester. Place the other end of the paper strip in the other clamp. Make sure the long dimension of the strip is running parallel to the sides of the tensile tester. Also make sure the strips are not overhanging to the either side of the two clamps. In addition, the pressure of each of the clamps must be in full contact with the paper sample.

After inserting the paper test strip into the two clamps, the instrument tension can be monitored. If it shows a value of 5 grams or more, the sample is too taut. Conversely, if a period of 2-3 seconds passes after starting the test before any value is recorded, the tensile strip is too slack.

Start the tensile tester as described in the tensile tester instrument manual. The test is complete after the cross-head automatically returns to its initial starting position. Read and record the tensile load in units of grams from the instrument scale or the digital panel meter to the nearest unit.

If the reset condition is not performed automatically by the instrument, perform the necessary adjustment to set the instrument clamps to their initial starting positions. Insert the next paper strip into the two clamps as described above and obtain a tensile reading in units of grams. Obtain tensile readings from all the paper test strips. It should be noted that readings should be rejected if the strip slips or breaks in or at the edge of the clamps while performing the test.

If the percentage elongation at peak (% Stretch) is desired, determine that value at the same time tensile strength is being measured. Calibrate the elongation scale and adjust any necessary controls according to the manufacturer's instructions.

For electronic tensile testers with digital panel meters read and record the value displayed in a second digital panel meter at the completion of a tensile strength test. For some electronic tensile testers this value from the second digital panel meter is percentage elongation at peak (% stretch); for others it is actual inches of elongation.

Repeat this procedure for each tensile strip tested.

Calculations: Percentage Elongation at Peak (% Stretch)—For electronic tensile testers displaying percentage elongation in the second digital panel meter:
Percentage Elongation at Peak (% Stretch)=(Sum of elongation readings) divided by the (Number of readings made).
For electronic tensile testers displaying actual units (inches or centimeters) of elongation in the second digital panel meter:
Percentage Elongation at Peak (% Stretch)=(Sum of inches or centimeters of elongation) divided by ((Gauge length in inches or centimeters) times (number of readings made))
Results are in percent. Whole number for results above 5%; report results to the nearest 0.1% below 5%.
Horizontal Full Sheet (HFS) Absorbency Test:

The Horizontal Full Sheet (HFS) test method determines the amount of distilled water absorbed and retained by the paper of the present invention. This method is performed by first weighing a sample of the paper to be tested (referred to herein as the “Dry Weight of the paper”), then thoroughly wetting the paper, draining the wetted paper in a horizontal position and then reweighing (referred to herein as “Wet Weight of the paper”). The absorptive capacity of the paper is then computed as the amount of water retained in units of grams of water absorbed by the paper. When evaluating different paper samples, the same size of paper is used for all samples tested.

The apparatus for determining the HFS capacity of paper comprises the following: An electronic balance with a sensitivity of at least +0.01 grams and a minimum capacity of 1200 grams. The balance should be positioned on a balance table and slab to minimize the vibration effects of floor/benchtop weighing. The balance should also have a special balance pan to be able to handle the size of the paper tested (i.e.; a paper sample of about 11 in. (27.9 cm) by 11 in. (27.9 cm)). The balance pan can be made out of a variety of materials. Plexiglass is a common material used.

A sample support rack and sample support cover is also required. Both the rack and cover are comprised of a lightweight metal frame, strung with 0.012 in. (0.305 cm) diameter monofilament so as to form a grid of 0.5 inch squares (1.27 cm²). The size of the support rack and cover is such that the sample size can be conveniently placed between the two.

The HFS test is performed in an environment maintained at 23±1° C. and 50±2% relative humidity. A water reservoir or tub is filled with distilled water at 23±1° C. to a depth of 3 inches (7.6 cm).

The paper to be tested is carefully weighed on the balance to the nearest 0.01 grams. The dry weight of the sample is reported to the nearest 0.01 grams. The empty sample support rack is placed on the balance with the special balance pan described above. The balance is then zeroed (tared). The sample is carefully placed on the sample support rack. The support rack cover is placed on top of the support rack. The sample (now sandwiched between the rack and cover) is submerged in the water reservoir. After the sample has been submerged for 60 seconds, the sample support rack and cover are gently raised out of the reservoir.

The sample, support rack and cover are allowed to drain horizontally for 120±5 seconds, taking care not to excessively shake or vibrate the sample. Next, the rack cover is carefully removed and the wet sample and the support rack are weighed on the previously tared balance. The weight is recorded to the nearest 0.01 g. This is the wet weight of the sample.

The gram per paper sample absorptive capacity of the sample is defined as (Wet Weight of the paper−Dry Weight of the paper).

All documents cited in the Detailed Description of the Invention are, in relevant part, incorporated herein by reference; the citation of any document is not to be considered as an admission that it is prior art with respect to the present invention.

While particular embodiments of the present invention have been illustrated and described, it would be obvious to those skilled in the art that various other changes and modifications can be made without departing from the spirit and scope of the invention.

1. A patterned fibrous structure comprising latex.

2. The patterned fibrous structure according to claim 1 wherein the fibrous structure comprises a first surface and a second surface, wherein at least one of the first and second surfaces exhibits a deformation height of at least about 650 μm.

3. The patterned fibrous structure according to claim 1 wherein the fibrous structure is a wet laid fibrous structure.

4. The patterned fibrous structure according to claim 1 wherein the fibrous structure is an air laid fibrous structure.

5. The patterned fibrous structure according to claim 1 wherein the latex is a natural and/or synthetic latex.

6. The patterned fibrous structure according to claim 5 wherein the latex has a Tg of from about −65° C. to about 100° C.

7. The patterned fibrous structure according to claim 5 wherein the latex is a synthetic latex selected from the group consisting of vinyl acetates, ethylene-vinyl acetate copolymers, acrylate copolymers, styrene butadiene copolymers and mixtures thereof.

8. The patterned fibrous structure according to claim 1 wherein the fibrous structure exhibits substantially uniform density.

9. The patterned fibrous structure according to claim 1 wherein the fibrous structure exhibits regions of high and low density relative to each other.

10. The patterned fibrous structure according to claim 9 wherein the latex is substantially present in the high density regions of the fibrous structure.

11. The patterned fibrous structure according to claim 1 wherein both the first and second surfaces exhibit a deformation height of at least about 650 μm.

12. The patterned fibrous structure according to claim 1 wherein the fibrous structure exhibits an HFS absorbency of greater than about 8 g/g.

13. The patterned fibrous structure according to claim 1 wherein the fibrous structure exhibits a Stretch at Peak Load, in any direction, of greater than about 10%.

14. The patterned fibrous structure according to claim 1 wherein the fibrous structure exhibits a sheet caliper of at least about 20 mils.

15. The patterned fibrous structure according to claim 1 wherein the fibrous structure exhibits a wet burst of at least about 100 g.

16. The patterned fibrous structure according to claim 1 wherein the fibrous structure, when in roll form, exhibits an average effective caliper that is greater than the average sheet caliper of an identical fibrous structure in its non-patterned form.

17. A single- or multi-ply sanitary tissue product comprising a fibrous structure according to claim 1.

18. The sanitary tissue product according to claim 17 wherein the sanitary tissue product, when in roll form, exhibits an average effective caliper that is greater than the average sheet caliper of an identical sanitary tissue product in its non-patterned form.

19. A method for making a patterned fibrous structure comprising latex and/or a single-ply sanitary tissue product comprising such patterned fibrous structure, said method comprising the steps of:
a. providing a fibrous structure comprising latex; and
b. subjecting the fibrous structure to a deformation generating process such that a patterned fibrous structure and/or single-ply sanitary tissue product comprising such patterned fibrous structure is formed.

20. The method according to claim 19 wherein the method further comprises the step of curing the latex.

21. A method for making a patterned fibrous structure comprising latex and/or a single-ply sanitary tissue product comprising such patterned fibrous structure, said method comprising the steps of:
a. providing a patterned fibrous structure and/or single-ply sanitary tissue product comprising such patterned fibrous structure; and
b. applying latex to the patterned fibrous structure and/or the single-ply sanitary tissue product comprising such patterned fibrous structure.

22. The method according to claim 21 wherein the method further comprises the step of curing the latex.

23. A method for making a patterned fibrous structure comprising latex and/or a single-ply sanitary tissue product comprising such patterned fibrous structure, said method comprising the steps of:
a. providing a fibrous furnish;
b. depositing the fibrous furnish on a foraminous forming surface to form an embryonic fibrous web;
c. drying the embryonic fibrous web such that a fibrous structure is formed;
d. applying latex to the fibrous furnish and/or the embryonic fibrous web and/or the fibrous structure; and
e. subjecting the fibrous structure to a deformation generating process such that a patterned fibrous structure and/or a single-ply sanitary tissue product comprising such patterned fibrous structure is formed.

24. The method according to claim 23 wherein the method further comprises the step of drying the fibrous structure and/or curing the latex.

25. A method for making a patterned fibrous structure comprising latex and/or a single-ply sanitary tissue product comprising such patterned fibrous structure, said method comprising the steps of:
a. providing an airborne fiber stream;
b. depositing the airborne fiber stream onto a forming surface to form an air laid fibrous structure;
c. applying latex to the air laid fibrous structure; and
d. subjecting the air laid fibrous structure to a deformation generating process such that a patterned air laid fibrous structure and/or single-ply sanitary tissue product comprising such patterned air laid fibrous structure is formed.

26. The method according to claim 25 wherein the method further comprises the step of curing the latex.

27. A method for making a patterned multi-ply sanitary tissue product, said method comprising the steps of:
a. providing a first fibrous structure;
b. providing a second fibrous structure;
c. attaching the second fibrous structure to the first fibrous structure to form a multi-ply sanitary tissue product;
d. subjecting at least one surface of the first fibrous structure, second fibrous structure and/or the multi-ply sanitary tissue product to a deformation generating process such that a patterned sanitary tissue product is formed; and
e. applying latex to at least one of the first fibrous structure, the second fibrous structure and/or the multi-ply sanitary tissue product.

28. The method according to claim 27 wherein the method further comprises the step of curing the latex.
